(19) United States
(12) Patent Application Publication
(10) Pub. No.: US 2026/0155700 A1
(43) Pub. Date: Jun. 4, 2026

(54) ELECTRICALLY EXCITED SYNCHRONOUS MACHINE

(71) Applicant: MAHLE International GmbH, Stuttgart (DE)

(72) Inventors: Thorsten Grelle, Stuttgart (DE); Florian Osdoba, Stuttgart (DE); Penyo Topalov, Stuttgart (DE); Philipp Zimmerschied, Stuttgart (DE)

(21) Appl. No.: 18/705,523

(22) PCT Filed: Oct. 5, 2022
(86) PCT No.: PCT/EP2022/077662

§ 371 Date: Apr. 26, 2024

(30) Foreign Application Priority Data
Oct. 28, 2021 (EP) 10 2021 212 205.1

(51) Int. Cl. H02K 5/15; H02K 5/20; H02K 7/00; H02K 9/19

(52) U.S. Cl. CPC H02K 5/15; H02K 5/203; H02K 7/003; H02K 9/19

(57) ABSTRACT

An electrically excited synchronous machine may include a stator, a rotor, an energy transmission system, and a stator-fixed power electronics. The stator may include a stator housing. The stator housing may include at least one axially front-side bearing shield and a stator coil for generating a magnetic stator field. The rotor may include (i) a rotor shaft rotatably mounted at least on the at least one bearing shield about an axis of rotation and (ii) a rotor coil for generating a magnetic rotor field. The energy transmission system may include an energy transmitter for transmitting electrical energy to the rotor coil. The at least one bearing shield may include at least one coolant duct, a coolant inlet, and a coolant outlet. At least one component of the stator-fixed power electronics may be arranged on the at least one bearing shield in a heat transmitting manner.

### CROSS-REFERENCE TO RELATED APPLICATIONS

This application claims priority to International Patent Application No. PCT/EP 2022/077662, filed on Oct. 5, 2022, and German Patent Application No. DE 10 2021 212 205.1, filed on Oct. 28, 2021, the contents of both of which are hereby incorporated by reference in their entirety.

### TECHNICAL FIELD

An electrically excited synchronous machine comprises a stator, a rotor and an energy transmission system. The stator has a stator housing comprising at least one axially front-side bearing shield and a stator coil for generating a magnetic stator field. The rotor has a rotor shaft rotatably mounted at least on the bearing shield about an axis of rotation and a coil for generating a magnetic rotor field. The energy transmission system serves the purpose of transmitting electrical energy to the rotor coil and thus effects the electrical external excitation. In the case of an inductively operating energy transmission system, the latter can be equipped with an inductive energy transmitter, which can preferably be designed as rotary transformer, which has a stator-fixed primary transformer coil and a rotor-fixed secondary transformer coil.

### BACKGROUND

High-performance synchronous machines are subjected to a high thermal stress. This applies in particular for all electrically active components or component parts, which contribute to the generation of the magnetic fields and to the electrical energy transmission, thus preferably for the energy transmitter as well as for a power electronics of the synchronous machine.

The synchronous machine is preferably designed as traction motor for a motor vehicle, which can in particular absorb an electrical power of 100 kW to 240 kW, preferably of 120 kW to 160 kW, particularly preferably of approximately 140 kW.

It is generally conceivable to cool the synchronous machine. The integration of a cooling jacket into the stator housing is common thereby. A suitable, in particular liquid, coolant can flow through the cooling jacket. It is further conceivable to arrange particularly vulnerable components of the power electronics so that the heat transmission to these components is reduced and/or the heat dissipation from these components is improved. However, this is generally associated with a high structural effort and a relatively large installation space requirement. Comparatively long electrical lines can further become necessary, which complicates the operation of the drive system and has a disadvantageous effect on the efficiency thereof and which increases the susceptibility of failure of the power electronics.

### SUMMARY

The present invention deals with the problem of specifying an improved or at least a different embodiment for a synchronous machine of the above-described type, which is in particular characterized by an improved heat dissipation. In particular an increased degree of integration and/or a higher power density are further desired.

This problem is solved according to the invention by means of the subject matter of the independent claim(s). Advantageous embodiments are subject matter of the dependent claim(s).

The invention is based on the general idea of actively cooling the bearing shield and to utilize at least one component of the power electronics of the synchronous machine for the assembly. On the one hand, an efficient cooling of the respective component of the power electronics is realized thereby. On the other hand, a compact construction is also realized thereby, which provides for short connecting paths, for example between the energy transmitter and the respective component of the power electronics. The shortened electrical lines lead to a reduction of the generation of and susceptibility to failures as well as interfering parasitic effects and power losses associated therewith as well as power inductances and power capacitances.

In detail, the invention proposes to equip the bearing shield with at least one coolant duct as well as with a coolant inlet and a coolant outlet, so that the bearing shield is actively cooled by means of an, in particular liquid, coolant guided through the coolant duct. At least one component of the stator-fixed power electronics of the synchronous machine is arranged on the bearing shield so as to transmit heat. On the one hand, a heat input into the respective component of the power electronics is reduced thereby, while on the other hand, waste heat of the respective component of the power electronics can be dissipated.

The respective component of the power electronics is preferably arranged on an axial outer side of the bearing shield.

The heat-transmitting coupling between the respective component of the power electronics and the bearing shield can be realized directly by means of an, in particular pre-stressed, attachment and/or indirectly by means of the use of thermally conductive materials, such as, for example, thermal paste and thermal pads. Expediently, a pre-stressed indirect application can also take place via thermally conductive material.

In the case of an advantageous embodiment, the coolant duct can run in an annular region of the bearing shield arranged concentrically to the axis of rotation and can extend therein over at least 180°, preferably over at least 270°, in the circumferential direction. The respective component of the power electronics is arranged on the bearing shield so as to transmit heat in this annular region. This results in a particularly efficient heat dissipation.

In the case of another embodiment, the coolant duct can run in an annular segment-shaped cooling region of the bearing shield, which runs concentrically to the axis of rotation and which extends over at least 90°, preferably over at least 180°, in the circumferential direction. Expediently, the respective component of the power electronics is arranged on the bearing shield so as to transmit heat in this cooling region. An efficient heat transmission is also supported here. It is likewise conceivable that individual, thermally particularly sensitive and/or stressed component parts are embedded into the cooling circuit. The can take place, for example, by means of recesses or depressions, in which the corresponding component parts are arranged.

In the case of an advantageous further development, the coolant duct can extend in a meander-shaped manner in the cooling region and can run back and forth between a radially inner inner end of the cooling region and a radially outer outer end of the cooling region. The cooling effect can be improved thereby because the surface available for the heat transmission is enlarged.

Alternatively, the cooling effect can also be improved in that in the cooling region, the coolant duct has a flat cross section, which can be flown through and which extends from a radially inner inner end of the cooling region all the way to a radially outer outer end of the cooling region, This measure can also improve the heat dissipation because the surface available for the heat transmission is enlarged.

In the case of a further development, a cooling structure can be arranged or formed in the flat cross section of the coolant duct. The cooling structure improves the heat transmission between coolant and bearing shield. The cooling structure can represent at least one separate component part, which is inserted into the coolant duct. It is likewise conceivable to form the cooling structure integrally on the bearing shield. The cooling structure can have ribs and/or nubs and/or fins and/or pins and/or the like.

The energy transmitter can generally be designed as conductively operating energy transmitter, which conductively transmits the electrical energy. The conductive energy transmitter can in particular have a slider assembly, which has at least one stator-fixed sliding contact. The respective sliding contact, which is in particular designed as brush, can be arranged in or on the bearing shield so as to transmit heat, in particular radially to the axis of rotation. On the rotor side, the conductive energy transmitter can have at least one rotor-fixed slip ring, with which the respective sliding contact cooperates. The respective slip ring can be formed, for example, on the rotor shaft.

However, an embodiment is preferred, in the case of which the energy transmitter is configured as inductively operating energy transmitter, so that it effects an inductive transmission of electrical energy to the rotor coil. Expediently, the inductive energy transmitter is equipped with a rotary transformer or is designed as such, which has a stator-fixed primary transformer coil and a rotor-fixed secondary transformer coil. The primary transformer coil thereby represents a stator-fixed component of the energy transmitter. The inductively operating energy transmission system then expediently has a rotor-side or rotor-fixed rectifier, respectively, which electrically connects the secondary transformer coil to the rotor coil.

For the improved electromagnetic coupling between the two transformer coils, the energy transmitter can have a magnetic core or ferrite core, which is arranged concentrically to the axis of rotation and which is at least partly stator-fixed. The primary transformer coil is arranged in a stationary manner in this ferrite core, while the secondary transformer coil is rotatably arranged in the ferrite core. Such a ferrite core can be designed as a whole as stator-fixed ferrite core or can have a stator-fixed ferrite core part and a rotor-fixed ferrite core part. In the following, reference will be made throughout to the ferrite core, whereby this then generally in each case refers to the entire stator-fixed ferrite core and the stator-fixed ferrite core part.

A further development is now particularly advantageous, in the case of which the ferrite core or the stator-fixed ferrite core part, respectively, is arranged in a rotationally fixed manner in or on the bearing shield so as to transmit heat, so that the coolant duct runs in the bearing shield radially outside of the ferrite core. By means of the encapsulation of the rotary transformer by means of the ferrite core, the ferrite core absorbs heat, which is generated in response to the transmission in the rotary transformer. This heat can now be transmitted particularly favorably to the bearing shield and can be dissipated by means of the coolant.

The thermal protection can also be improved in that the ferrite core is arranged on an axial outer side of the bearing shield. The bearing shield can in particular be arranged axially between the ferrite core and a rectifier of the energy transmitter. For installation space reasons, however, it can be expedient to arrange the ferrite core on the axial inner side of the bearing shield.

According to an advantageous embodiment, it can be provided that the bearing shield has a receptacle, in which the stator-fixed component of the energy transmitter is arranged. On the one hand, the positioning of the respective component is simplified thereby, while on the other hand, the heat transmission is improved. This effects can optionally be improved when it is provided that the receptacle has an enclosure, the radial inner contour of which is adapted to a radial outer contour of the stator-fixed component of the energy transmitter. The respective component can abut axially in the receptacle and radially on the optional enclosure, wherein an indirect abutment via a thermally conductive material or a direct abutment are conceivable. Provided that the stator-fixed component in the case of an inductive energy transmitter is a ferrite core, the receptacle can be designed as core receptacle, which receives the ferrite core. The optional enclosure encloses the ferrite core radially. The ferrite core then abuts axially in the core receptacle and radially against the enclosure, directly or indirectly.

In the case of an advantageous further development, the ferrite core can be arranged concentrically in the above-mentioned annular region. Additionally or alternatively, the ferrite core can be arranged concentrically to the cooling region mentioned further above. By means of the concentric arrangement, heat, which is dissipated radially into the bearing shield by the ferrite core, can reach directly into the annular region or into the cooling region, respectively, and can be absorbed by the coolant from there.

In the case of an advantageous embodiment, the stator housing can be designed so that it does not have a stator cooling comprising stator coolant duct running in the stator housing. It has been shown that, depending on the form of application, the active cooling of the bearing shield is sufficient to realize a sufficient cooling. For example, an additional passive cooling by means of an air flow within the/through the electrical machine is conceivable thereby. This air flow can be guided along the cooled bearing shields, whereby an additional indirect cooling can optionally be achieved by means of the bearing shields.

According to another embodiment, it can be provided, in contrast, that the stator housing has a stator cooling comprising stator coolant duct, which runs in the stator housing and which is fluidically separated from the coolant duct in the bearing shield. By means of the fluidic separation of the stator coolant duct and of the coolant duct of the bearing shield, the cooling of the bearing shield can be optimized towards the conditions there. In particular, different pressures, coolants, flow speeds and coolant temperatures can be used in the coolant duct of the bearing shield on the one hand and in the stator coolant duct on the other hand.

In the case of another alternative embodiment, the synchronous machine can be designed as wet-running electrical machine. The synchronous machine then has a cooling circuit, which guides a coolant through an interior space of the stator housing, in which the rotor and routinely also the stator is in contact with the coolant. This cooling circuit can now be fluidically coupled to the coolant duct of the bearing shield. The cooling of the bearing shield is simplified thereby.

A pure rotor cooling or a pure stator cooling or a combined rotor-stator cooling are conceivable at this point. A rotor spray cooling, which runs through the rotor (e.g., supply via the rotor shaft) and cooling medium is thus flung from the rotor to the stator, as well as a cooling by means of nozzles/outlets, which spray rotor and/or stator (optionally additional atomization by means of the rotor) are to be named as exemplary embodiments. An embodiment as wet-running synchronous machine can make a stator jacket cooling superfluous.

In the case of another embodiment, the rotor can have a rotor cooling, in particular as or in combination with a rotor spray cooling, comprising a rotor coolant duct, which runs in the rotor and which is fluidically coupled to the coolant duct in the bearing shield. The realization of the cooling of the bearing shield is also simplified thereby. An embodiment, in the case of which the coolant duct of the bearing shield is arranged upstream of the rotor coolant duct, is particularly expedient thereby.

It can in particular be provided thereby that the coolant duct is connected with its coolant outlet to a coolant inlet region of the rotor cooling. The cooling of the bearing shield is thus located upstream of the cooling of the rotor.

Additionally or alternatively, it can be provided thereby that the coolant outlet is oriented axially and is arranged on an axial inner side of the bearing shield. This simplifies the fluidic coupling of the bearing shield cooling to the rotor cooling.

Additionally or alternatively, it can moreover be provided that the coolant inlet is oriented radially and is arranged on a radial outer circumference of the bearing shield. This measure simplifies the coupling of the synchronous machine to a cooling circuit.

Further important features and advantages of the invention follow from the subclaims, from the drawings and from the corresponding figure description on the basis of the drawings.

It goes without saying that the above-mentioned features and the features, which will be described below, cannot only be used in the respective specified combination but also in other combinations or alone, without leaving the scope of the invention. Component parts, which are mentioned above and which will be mentioned below, of a higher-level unit, such as, e.g., a means, a device or an assembly, which are identified separately, can form separate component parts or components, respectively, of this unit can be integral regions or sections, respectively, of this unit, even if this is illustrated differently in the drawings.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically:

FIG. 1 shows a partially cut isometric view onto an axial end region of a synchronous machine comprising energy transmission system,

FIG. 2 shows a simplified circuit diagram of an energy transmission system,

FIG. 3 shows an isometric view from the outside of a bearing shield without stator-fixed component, e.g., ferrite core, of an energy transmitter of the energy transmission system,

FIG. 4 shows a view as in FIG. 3 but with stator-fixed component, e.g., ferrite core, of the energy transmitter,

FIG. 5 shows an isometric longitudinal section of the bearing shield comprising stator-fixed component, e.g., ferrite core, of the energy transmitter,

FIG. 6 shows an axial view of the bearing shield from the inside,

FIG. 7 shows an axial view of the bearing shield from the outside in the case of another embodiment,

FIG. 8 shows an axial view of the bearing shield from the outside in the case of a further embodiment,

FIG. 9 shows an exploded view of an enlarged detail from FIG. 8.

### DETAILED DESCRIPTION

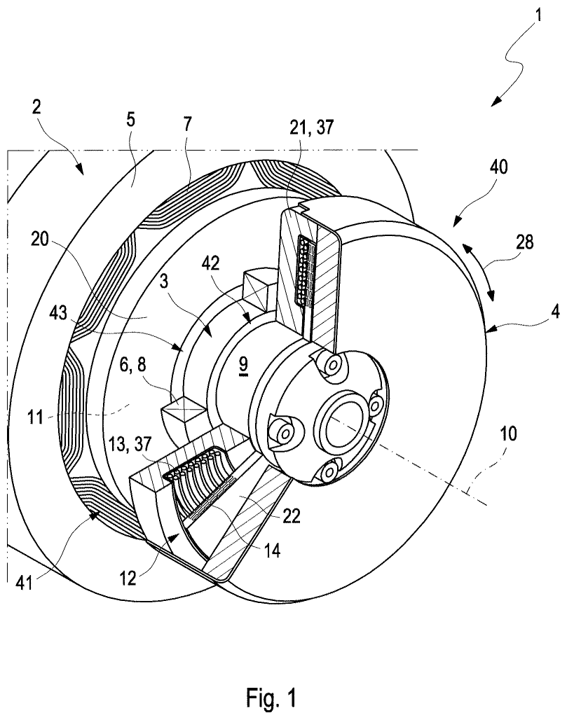

According to FIG. 1, an electrically excited synchronous machine 1, which is only partly illustrated here, has a stator 2, a rotor 3 and an energy transmission system 40. The stator 2 has a stator housing 5 comprising at least one axially front-side bearing shield 6 and a stator coil 7 for generating a magnetic stator field. Of the bearing shield 6, only one bearing 8 is shown in FIG. 1, which is arranged or formed, respectively, on the bearing shield 6. The rotor 3 has a rotor shaft 9 rotatably mounted at least on the bearing shield 6 about an axis of rotation 10. The rotor 3 moreover has a rotor coil 11 for generating a magnetic rotor field.

The energy transmission system 40 serves the purpose of transmitting electrical energy from an external, suitable energy source to the rotor coil 11. For this purpose, the energy transmission system 40 is equipped with an energy transmitter 4, which inductively or conductively effects the energy transmission. In the case of the example shown in the figures, an inductive energy transmitter 4 is shown, which represents a preferred embodiment.

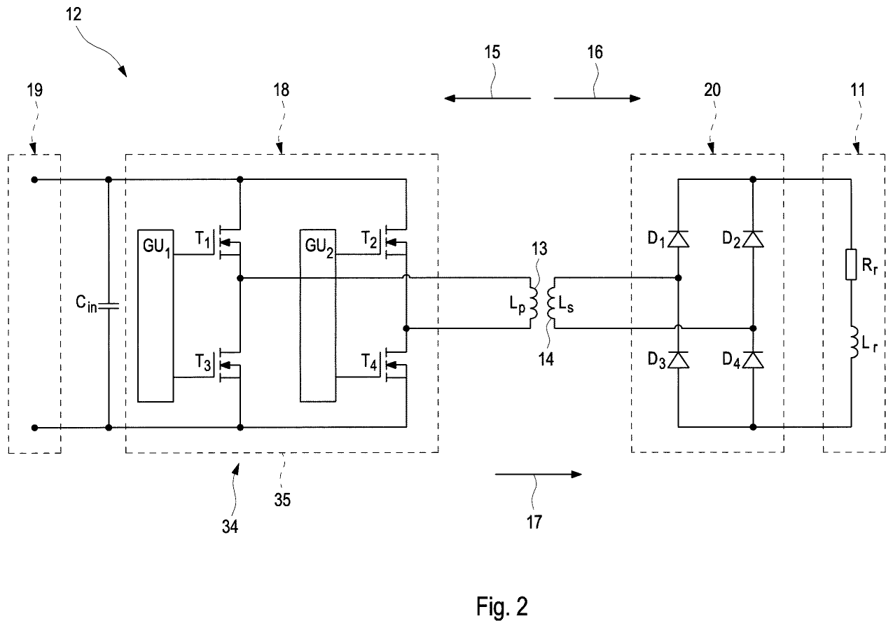

An inductive energy transmitter 4, which inductively transmits the energy to the rotor coil 11, is shown accordingly in FIGS. 1 and 2. Accordingly, this is an inductively electrically excited synchronous machine 1.

The inductive energy transmitter 4 is equipped with a rotary transformer 12, which is illustrated in the circuit diagram of FIG. 2. According to FIGS. 1 and 2, the rotary transformer 12 has a stator-fixed primary transformer coil 13 and a rotor-fixed secondary transformer coil 14. In FIG. 2, an arrow 15 suggests the stationary primary side of the rotary transformer 12, while an arrow 16 suggests the rotating secondary side of the rotary transformer 12. An arrow 17 suggests the energy flow during the operation of the synchronous machine 1.

An inverter 18 as well as a direct current source are moreover suggested on the primary side 15 in the circuit diagram of FIG. 2. A rectifier 20 and a rotor coil 11 are suggested on the secondary side 16.

The energy transmitter 4 is moreover equipped here with a stator-fixed ferrite core 21, which is arranged concentrically to the axis of rotation 10. The primary transformer coil 13 is arranged in a stationary manner in this ferrite core 21. The secondary transformer coil 14 is rotatably arranged in the ferrite core 21. The rotor shaft 9 passes through the ferrite core 21 and, on a disk 22 suggested in FIG. 1, carries the secondary transformer coil 14, which is connected in a rotationally fixed manner to the rotor shaft 9 via this disk 22. The primary transformer coil 13 and the ferrite core 21 in each case represent a stator-fixed component 37 of the energy transmitter 4. In the case of another, non-illustrated embodiment, the ferrite core 21 has a stator-fixed ferrite core part and a rotor-fixed ferrite core part.

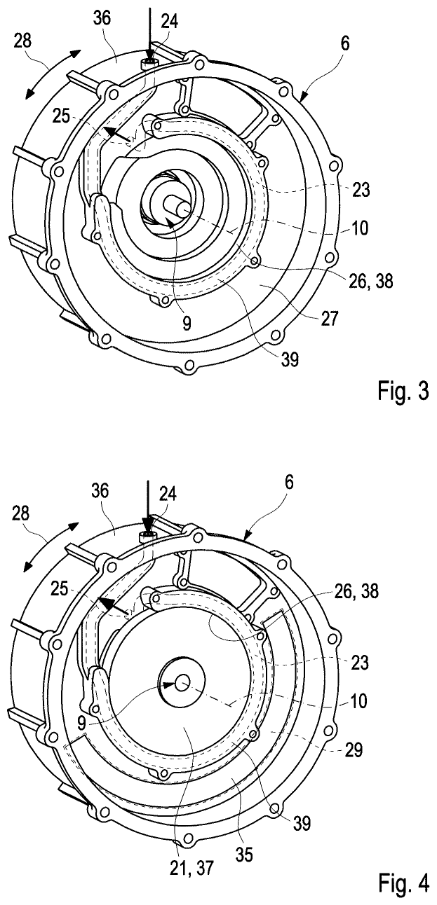

According to the FIGS. 3 to 7, the bearing shield 6 can be designed as separate component part with respect to the remaining stator housing 5. An embodiment is generally also conceivable, in the case of which the bearing shield 6 is integrally molded on the stator housing 5. According to the FIGS. 3 to 7, the bearing shield 6 has at least one coolant duct 23, which is formed in the interior of the bearing shield 6. The coolant duct 23 is thereby formed directly in the material of the bearing shield 6, so that a coolant flowing through the coolant duct 23 is directly in contact with the material of the bearing shield 6. The coolant is preferably a dielectric oil or a mixture of dielectric oil and air. The bearing shield 6 moreover has a coolant inlet 24 as well as a coolant outlet 25.

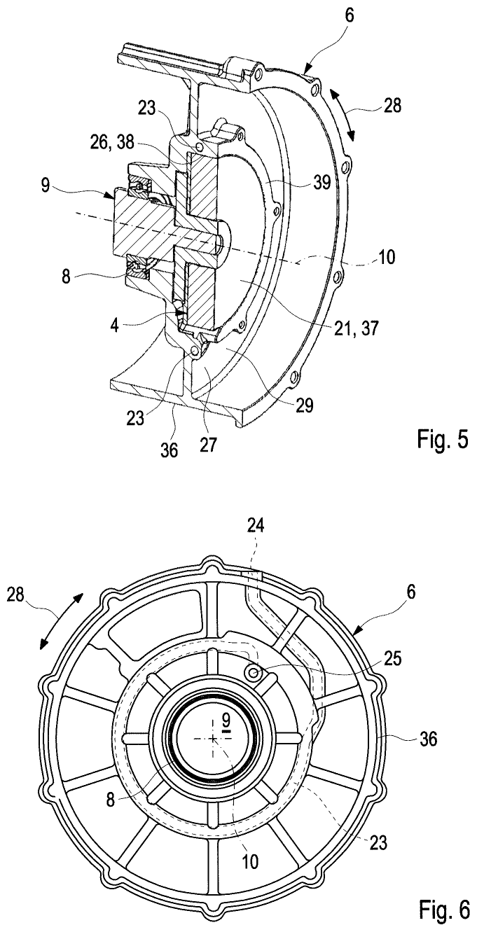

For the improved cooling of at least one stator-fixed component 37 of the energy transmitter 4, the respective component 37 can be arranged in or on the bearing shield 6 so as to transmit heat. For this purpose, the bearing shield 6 according to the FIGS. 4 and 5 can have a receptacle 38, into which the respective component 37 is inserted. The receptacle 38 has an enclosure 39, which revolves in the circumferential direction 28 in the manner of a collar and which is suggested by a double arrow in the FIGS. 1 and 3 to 8 and which revolves around the axis of rotation 10. This enclosure 39 engages around the component 37 inserted into the receptacle 38. In the concrete example, the receptacle 38 is designed as core receptacle 26, which is expediently formed in combination with the enclosure 39 complementary to the ferrite core 21.

According to the FIGS. 4 and 5, the ferrite core 21 is arranged in a rotationally fixed manner on or in the bearing shield 6, respectively, so as to transmit heat. For this purpose, said core receptacle 26 is formed in the bearing shield 6 with enclosure 39, which is or are formed, respectively, complementary to the ferrite core 21, so that the ferrite core 21 can be inserted in a rotationally fixed manner into the core receptacle 26. In the case of the preferred examples shown here, the core receptacle 26 and the ferrite core 21 are located on an axial outer side of the bearing shield 6, which faces away from the bearing housing 5 or from the rotor 3, respectively. The bearing shield 6 is thus in particular arranged axially between the ferrite core 21 and the rectifier 20.

The heat-transmitting coupling between the ferrite core and the bearing shield can be realized directly by means of a pre-stressed attachment and/or indirectly by means of the use of thermally conductive materials, such as, for example, thermal paste and thermal pads.

As can be gathered from the FIGS. 3 to 7, the coolant duct 23 is formed in an annular region 27 of the bearing shield 6, which is arranged concentrically to the ferrite core 21 and thus concentrically to the axis of rotation 19. The coolant duct 23 extends along the ferrite core 21 over at least 180° in the circumferential direction 28. The axis of rotation 10 thereby defines an axial direction of the synchronous machine 1, wherein the axial direction runs parallel to the axis of rotation 10. A radial direction stands perpendicular on the axis of rotation 10.

In the case of the examples shown here of FIG. 3 to 8, the coolant duct 23 runs over at least 360° in the circumferential direction 28. In the FIGS. 3 to 6, a first embodiment is shown, in the case of which the coolant duct 23, from the coolant inlet 24 all the way to the coolant outlet 25, quasi has a cross section, which can be flown through in an essentially constant manner and which is designed to be round, in particular circular, in the example. In the case of an embodiment not shown here, the coolant circuit 23 can be configured spirally, so that it extends over more than 360° in the circumferential direction 28. The coolant duct 23 can at least partly extend in the circumferential direction 28 within the enclosure 39 mentioned further above.

According to the FIGS. 3 to 8, an annular segment-shaped cooling region 29, which extends concentrically to the ferrite core 21 over at least 90° in the circumferential direction 28, can be formed on the bearing shield 6. In the shown examples, this cooling region 29 extends over approximately 180° in the circumferential direction 28.

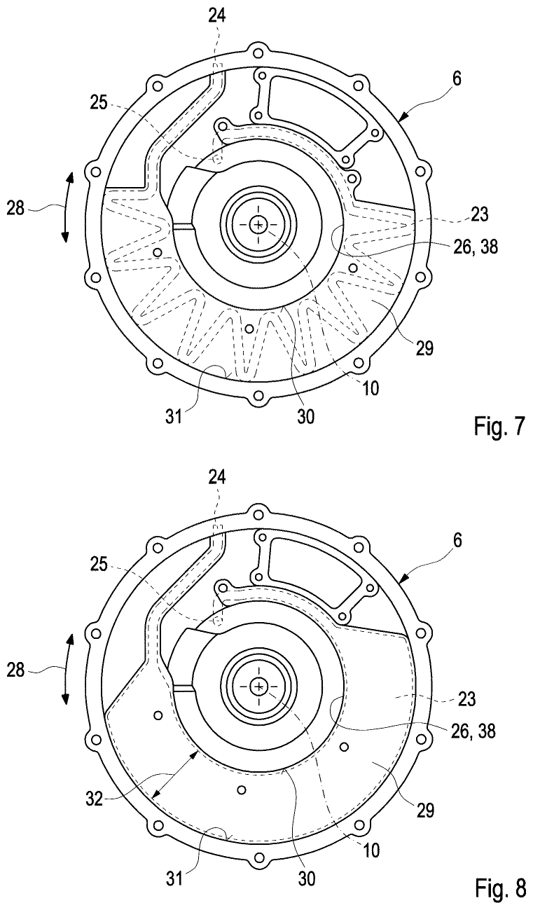

According to FIG. 7, the coolant duct 23 in the case of a second embodiment can extend in a meander-shaped manner within this cooling region 29. According to FIG. 7, the coolant duct 23 runs back and forth between a radially inner inner end 30 of the cooling region 29 and a radially outer outer end 21 of the cooling region 29 in the cooling region 29.

In the case of a third embodiment, the coolant duct 23 can alternatively have a flat cross section 32, which can be flown through, in the cooling region 29 according to FIG. 8. This flat cross section 32 extends from the radially inner inner end 30 of the cooling region 29 all the way to the radially outer outer end 31 of the cooling region 29. The cross section 32 of the coolant duct 23, which can be flown through, is flat because its width measured in the radial direction is larger, in particular at least 5 times larger, than its height measured in the axial direction.

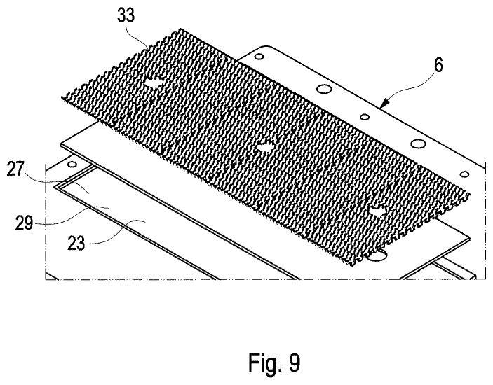

In the two cases of the second and third embodiment, a large-area cooling of the cooling region 29 is thus created on the bearing shield 6. According to FIG. 9, it can optionally be provided that a cooling structure 33, which improves the heat transmission between the bearing shield 6 and the coolant, is arranged in the flat cross section 32 of the coolant duct 23, thus within the cooling region 29. The cooling structure 33 can be formed with ribs, nubs, pins and the like as well as with any combination thereof.

The synchronous machine 1 has a power electronics 34, which has several components 35. For example, the inverter 18 of the rotary transformer 12 has such a component 35 of the power electronics 34. Further components of the power electronics 34, which are not shown here, however, can also be provided for supplying current to the stator coil 7 as well as for controlling the synchronous machine 1.

An assembly region for at least one component 35 of the power electronics 34 can be created on the bearing shield 6 in the annular region 27 or in the cooling region 29, respectively. By means of the cooling of the bearing shield 6 and in particular by means of the intensive cooling of the cooling region 29, an overheating of the respective component 35 of the power electronics 34 can be prevented efficiently. Waste heat of this component 35 can in particular also be dissipated efficiently.

The heat-transmitting coupling between the ferrite core 21 and the bearing shield 6 on the one hand and between the respective component 35 of the power electronics 34 on the other hand can be realized by means of a pre-stressed attachment and/or by means of the use of thermally conductive materials, which are not shown here, such as, for example, thermal paste and thermal pads.

The bearing shield 6 can be a cast part, which can be produced with integrated coolant duct 23, for example with lost casting core. The bearing shield 6 can also be a 3D printed part. It is likewise conceivable to configure the bearing shield 6 in several parts in order to form the coolant duct 23 therein.

In the case of the examples shown here, the coolant inlet 24 is oriented radially and is arranged on a radial outer circumference 36 of the bearing shield 6. In contrast thereto, the coolant outlet 25 is oriented axially in the examples and is arranged on an inner side of the bearing shield 6, which, in the assembled state, faces the stator housing 5 and the observer only in FIG. 6. The coolant duct 23 can thereby be connected particularly easily via the coolant outlet 25 to a coolant inlet region 43 of a rotor cooling 41, which has, for example, a rotor coolant duct 42 guided through the rotor shaft 9.

In the case of the examples shown here, the ferrite core 21 and/or the respective component 35 of the power electronics 34 is arranged on an outer side facing away from the stator housing 5.

1. An electrically excited synchronous machine, comprising:
a stator including a stator housing, the stator housing including at least one axially front-side bearing shield and a stator coil for providing a magnetic stator field;
a rotor including (i) a rotor shaft rotatably mounted at least on the at least one bearing shield about an axis of rotation and (ii) a rotor coil for providing a magnetic rotor field;
an energy transmission system including an energy transmitter for transmitting electrical energy to the rotor coil;
a stator-fixed power electronics;
the at least one bearing shield including at least one coolant duct, a coolant inlet, and a coolant outlet such that the at least one bearing shield is actively cooled via a coolant guided through the at least one coolant duct; and
wherein at least one component of the stator-fixed power electronics is arranged on the at least one bearing shield in a heat transmitting manner.

2. The synchronous machine according to claim 1, wherein:
the at least one coolant duct extends in an annular region of the at least one bearing shield arranged concentrically to the axis of rotation and, in the annular region, extends over at least 180° in a circumferential direction; and
the at least one component is arranged on the at least one bearing shield in the annular region.

3. The synchronous machine according to claim 1, wherein:
the at least one coolant duct extends in a cooling region of the at least one bearing shield;
the cooling region is annular segment-shaped, extends concentrically to the axis of rotation, and extends over at least 90° in a circumferential direction; and
the at least one component is arranged on the at least one bearing shield in the cooling region.

4. The synchronous machine according to claim 3, wherein the at least one coolant duct extends in a meander-shaped manner in the cooling region and extends back and forth between a radially inner inner end of the cooling region and a radially outer outer end of the cooling region.

5. The synchronous machine according to claim 3, wherein, in the cooling region, the at least one coolant duct has a flat cross section through which the coolant is flowable and which extends from a radially inner inner end of the cooling region to a radially outer outer end of the cooling region.

6. The synchronous machine according to claim 5, wherein a cooling rib structure is at least one of arranged and formed in the flat cross section of the at least one coolant duct.

7. The synchronous machine according claim 1, wherein:
for inductive transmission of electrical energy, the energy transmitter includes a rotary transformer;
the rotary transformer includes a stator-fixed primary transformer coil, a rotor-fixed secondary transformer coil, and an at least partly stator-fixed ferrite core;
the ferrite core is arranged concentrically to the axis of rotation;
the primary transformer coil is arranged in the ferrite core in a stationary manner; and
the secondary transformer coil is rotatably arranged at least one of in and on the ferrite core.

8. The synchronous machine according to claim 7, wherein:
the ferrite core is arranged at least partially in a rotationally fixed manner in the at least one bearing shield in a heat transmitting manner; and
the at least one coolant duct runs extends in the at least one bearing shield radially outside of the ferrite core.

9. The synchronous machine according to claim 8, wherein:
the at least one coolant duct extends in an annular region of the at least one bearing shield arranged concentrically to the axis of rotation and, in the annular region, extends over at least 180° in a circumferential direction;
the at least one component is arranged on the at least one bearing shield in the annular region; and
the ferrite core is arranged concentrically in the annular region.

10. The synchronous machine according to claim 8, wherein:
the at least one coolant duct extends in a cooling region of the at least one bearing shield;
the cooling region is annular segment-shaped, extends concentrically to the axis of rotation, and extends over at least 90° in a circumferential direction;
the at least one component is arranged on the at least one bearing shield in the cooling region; and
the ferrite core is arranged concentrically to the cooling region.

11. The synchronous machine according to claim 7, wherein the at least one bearing shield includes a core receptacle in which the ferrite core is arranged.

12. The synchronous machine according to claim 11, wherein the core receptacle has an enclosure with a radial inner contour that is adapted to a radial outer contour of the ferrite core.

13. The synchronous machine according to claim 1, wherein the stator housing does not include a stator cooling having a stator coolant duct extending in the stator housing.

14. The synchronous machine according to claim 1, wherein the stator housing further includes a stator cooling having a stator coolant duct, the stator coolant duct extending in the stator housing and fluidically separated from the at least one coolant duct of the at least one bearing shield.

15. The synchronous machine according to claim 1, further comprising a cooling circuit, wherein:
the synchronous machine is configured as a wet-running electrical machine;
the cooling circuit guides the coolant through an interior space of the stator housing, in which the rotor is in contact with the coolant; and
the cooling circuit is fluidically coupled to the at least one coolant duct of the at least one bearing shield.

16. The synchronous machine according to claim 1, wherein the rotor further includes a rotor cooling having a rotor coolant duct extending in the rotor and fluidically coupled to the at least one coolant duct of the at least one bearing shield.

17. The synchronous machine according to claim 16, wherein the at least one coolant duct is connected via the coolant outlet to a coolant inlet region of the rotor cooling.

18. The synchronous machine according to claim 17, wherein the coolant outlet is axially oriented and is arranged on an axial inner side of the at least one bearing shield.

19. The synchronous machine according to claim 18, wherein the coolant inlet is oriented radially and is arranged on a radial outer circumference of the at least one bearing shield.

20. The synchronous machine according to claim 12, wherein the at least one coolant duct is disposed at least partially within the enclosure and, within the enclosure, extends at least partially around the core receptacle in a circumferential direction.
